(19) United States
(12) Patent Application Publication
(10) Pub. No.: US 2016/0251010 A1
(43) Pub. Date: Sep. 1, 2016

(54) CONTROL SYSTEM FOR A VEHICLE

(71) Applicant: TOYOTA JIDOSHA KABUSHIKI KAISHA, Toyota-shi, Aichi-ken (JP)

(72) Inventors: Kensei Hata, Okazaki-shi Aichi (JP); Yuji Iwase, Toyota-shi Aichi (JP); Yosuke Suzuki, Seto-shi Aichi (JP); Koichi Kato, Okazaki-shi Aichi (JP); Hirotatsu Kitabatake, Toyota-shi Aichi-ken (JP); Seitaro Nobuyasu, Okazaki-shi Aichi (JP); Taro Moteki, Okazaki-shi Aichi (JP)

(21) Appl. No.: 15/030,780

(22) PCT Filed: Oct. 22, 2014
(86) PCT No.: PCT/JP2014/078678

§ 371 Date: Apr. 20, 2016

(30) Foreign Application Priority Data
Oct. 24, 2013 (JP) 2013-221419

(51) Int. Cl. B60W 20/10; B60K 6/445; B60K 6/387; B60W 20/40; B60W 30/188

(52) U.S. Cl. CPC B60W 20/10; B60W 20/40; B60W 30/1882; B60K 6/387; B60K 6/445; B60W 2030/206

(57) ABSTRACT

A control system for a vehicle having an engine and a motor configured to reduce torque pulses and vibrations. The control system is comprised of a determining means that determines a target operating point of the engine at which a target engine power based on a required driving force is generated while improving fuel economy (step S1); and an electric vehicle mode setting means that shift a driving mode to the EV mode to drive the vehicle by the motor, if a target engine speed to be achieved at the target operating point determined by the determining means is lower than a predetermined threshold value (steps S2, S6).

### TECHNICAL FIELD

This disclosure relates to a control system for a vehicle having a clutch adapted to gradually change torque transmitting capacity thereof and to selectively disconnect an engine from a power train.

### BACKGROUND ART

An example of the vehicle of this kind is disclosed in Japanese Patent Laid-Open No. 08-295140. According to the teachings of Japanese Patent Laid-Open No. 08-295140, the first gear element of the differential gear unit is coupled to the generator, the second gear element is coupled to the motor to serves as the output element, and the third gear element is coupled to the breaking means. The third gear element is also coupled to the engine via the clutch. Provided that an opening degree of the accelerator is larger than 80% and a vehicle speed is lower than 30 km/h, the engine is disconnected from the third gear element, and the vehicle is driven by powers of the motor and the generator.

Thus, according to the teachings of Japanese Patent Laid-Open No. 08-295140, the clutch may still remain to be disengaged even if the engine speed is low. In this case, torque pulses and resultant shocks may be worsened, that is, NVH (i.e., noise, vibrations and harshness) characteristics may be deteriorated.

### SUMMARY

The present disclosure has been conceived noting the foregoing technical problems, and it is an object of this disclosure to provide a vehicle control system for suppressing torque pulses generated by an engine and resultant vibrations in a vehicle having a clutch adapted to disconnect the engine selectively from a power train.

The control system of the present disclosure is applied to a vehicle in which a prime mover includes an engine and a motor. In order to achieve the above-explained objective, the control system is comprised of: a determining means that determines a target operating point of the engine at which a target engine power based on a required driving force can be generated while achieving a desired fuel economy; and an electric vehicle mode setting means that shift a driving mode to the electric vehicle mode to drive the vehicle by the motor, if a target engine speed to be achieved at the target operating point determined by the determining means is lower than a predetermined threshold value.

According to the present disclosure, a reference speed to cause resonances in a power train for transmitting a torque of the engine to driving wheels may be used as the threshold value.

A clutch is disposed on the power train to connect the engine selectively with the power train. To this end, the clutch is adapted to be engaged in a manner such that a torque transmitting capacity thereof is changed gradually.

The control system of the present disclosure is further comprised of a disengaging means that disengages the clutch if the target engine speed is lower than the threshold value.

The vehicle to which the control system of the present disclosure is applied is comprised of a power distribution device having three rotary elements to perform a differential action, and the motor includes a first motor having a generating function and a second motor. In the vehicle, specifically, the first motor is connected with a first rotary element, the engine is connected with a second rotary element through the clutch, and the second motor is connected with a third rotary element serving as an output element to transmit a driving force to the driving wheels.

The control system of the present disclosure is configured to shift the driving mode to a motoring electric vehicle mode to engage the clutch to raise the speed of the engine by the first motor, provided that the vehicle is driven by the second motor while disengaging the clutch, and that a speed of the vehicle exceeds a predetermined reference speed.

The vehicle to which the control system of the present disclosure is applied is comprised of an electric storage device connected with the first motor and the second motor. Meanwhile, the control system of the present disclosure is further comprised of: a shifting means that shifts the target operating point of the engine determined by the determining means to another target operating point at which the target engine speed is higher than the threshold value, if the target engine speed achieved at the target operating point of the engine determined by the determining means is lower than the threshold value, and a state of charge of the electric storage device is smaller than a predetermined threshold value; an engaging means that engages the clutch to drive the engine at said another operating point shifted by the shifting means; and a charging means that charges the electric storage device by generating an electric power by rotating the first motor by a surplus power of the engine, if the clutch is engaged by the engaging means, and the power generated by engine driven at said another operating point is larger than the power necessary to drive the vehicle.

Thus, the control system of the present disclosure is configured to determine the target operating point of the engine at which the target engine power based on a required driving force can be generated while achieving a desired fuel economy, and if the target engine speed to be achieved at the determined target operating point is lower than a predetermined threshold value, the vehicle is driven by a torque of the motor. That is, provided that the engine speed is within the low speed region where the torque pulses may appear on the power train, the vehicle is allowed to be driven while disconnecting the engine from the power train and stopping the engine. Therefore, the NVH characteristics of the vehicle will not be deteriorated. To this end, specifically, the clutch is disposed on the power train, and the engine is disconnected from the power train by disengaging the clutch when the engine speed is lower than the threshold value. In addition, the clutch is adapted to be engaged while causing a slip so that an engagement shock will not be caused. Therefore, a spring having high stiffness may be used in a torsional damper for damping the vibrations of the power train. Consequently, an acceleration response of the vehicle can be improved.

As described, in the vehicle to which the control system of the present disclosure is applied, the first motor is connected with the first rotary element, the engine is connected with the second rotary element through the clutch, and the second motor is connected with the third rotary element. Provided that the vehicle is driven by the second motor while disengaging the clutch, and that the vehicle speed exceeds the predetermined speed, the clutch is engaged and the engine is rotated by the first motor. In this situation, specifically, the clutch is engaged while lowering the rotational speed of the second rotary element to zero by the first motor. Thus, the rotational speed of the second rotary element will not be raised excessively when engaging the clutch so that the power distribution is prevented from being damaged. In addition, since the engine has already been rotated by the first motor, the rotational speed of the engine can be raised smoothly to start the engine by the first motor when the driving mode is shifted to drive the vehicle by the engine. Further, the current to be applied to the first motor can be reduced.

As also described, the control system of the present disclosure is configured to drive the engine at another target operating point at which the target engine speed is higher than the threshold value, if the target engine speed to be achieved at the former target operating point of the engine is lower than the threshold value, and a state of charge of the electric storage device is smaller than a predetermined threshold value. In this case, the engine is connected with the powertrain by engaging the clutch, and if the engine is allowed to generate the power higher than the required power to drive the vehicle, the first motor is rotated by the surplus power of the engine to generate the electric power. Therefore, the electric storage device is allowed to be charged efficiently utilizing the surplus power of the engine.

### BRIEF DESCRIPTION OF THE DRAWINGS

FIG. 1 is a flowchart showing one example of the control to be carried out by the control system of the present disclosure.

FIG. 2 is a graph showing an example to change an operating point of the engine during the control shown in FIG. 1

FIG. 3 is a skeleton diagram showing one example of a structure of the vehicle to which the control system of the present disclosure is applied.

FIG. 4 is a table showing an engagement status of the clutch under each driving mode.

FIG. 5 is a nomographic diagram showing an operating state under each driving mode.

### DETAILED DESCRIPTION

The vehicle control system of the present disclosure is applied to a vehicle having a clutch for selectively disconnecting the engine from the power train. For this purpose, the clutch is adapted to be engaged gradually while changing a torque transmitting capacity thereof.

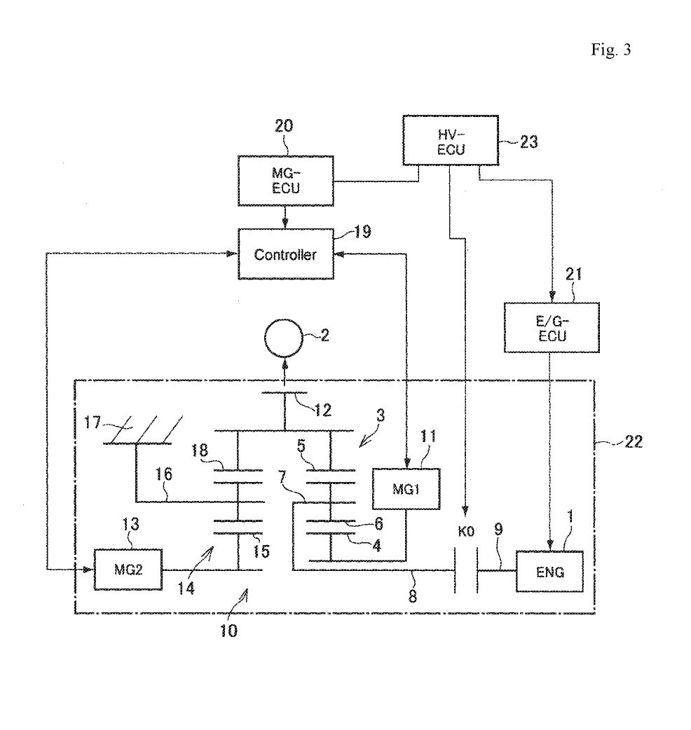

An example of a power train of the vehicle to which the present disclosure is applied is illustrated in FIG. 3. In the vehicle shown in FIG. 3, the power of the engine (ENG) 1 is partially transmitted to the driving wheels 2 by a mechanical means. The remaining power of the engine 1 is once converted into an electric power, and then converted into a mechanical power again to be transmitted to the driving wheels 2. In order to distribute the power of the engine 1, a power distribution device 3 is disposed on the power train 10. As the conventional two-motor type hybrid drive units, a single-pinion type planetary gear unit adapted to perform a differential action among three rotary elements is used as the power distribution device 3. Specifically, the power distribution device 3 is comprised of: a sun gear 4; a ring gear 5 arranged concentrically with the sun gear 4; a pinion gear 6 meshing with both the sun gear 4 and the ring gear 5; and a carrier 7 holding the pinion gear 6 in a manner such that the pinion gear 6 is allowed to rotate and revolve around the sun gear 4.

Specifically, the carrier 7 is connected with an input shaft 8 to serve as an input element. A clutch K0 is disposed between the input shaft 8 and an output shaft (i.e., a crankshaft) 9 of the engine 1. The clutch K0 is adapted to selectively connect and disconnect the engine 1 to/from the power distribution device 3 disposed on the power train 10. For this purpose, a friction clutch adapted to be engaged gradually is used as the clutch K0. Therefore, a torque transmitting capacity of the clutch K0 is changed gradually from a completely disengaged state until being engaged completely without causing a slip. For example, any of conventional dry-type clutch, wet type-clutch, single plate-type clutch, and multiple plate-type clutch may be used as the clutch K0. In addition, both hydraulic actuator and an electromagnetic actuator may be used to actuate the clutch K0. Provided that a conventional single plate-type dry clutch is employed as the clutch K0, the clutch K0 is kept to be engaged by a returning device such as a diaphragm spring when the actuator is not activated. That is, torque transmitting capacity of the clutch K0 is changed in proportion to a stroke of the actuator changed in accordance with a hydraulic pressure or a current applied thereto. Such relation between the torque transmitting capacity of the clutch K0 and the stroke of the actuator is preinstalled in the form of map. Here, if the friction coefficient of the friction surface of the clutch K0 is changed for some reason, the torque transmitting capacity of the clutch K0 with respect to a predetermined stroke will be changed.

The sun gear 4 is connected with the first motor-generator (MG1) 11 to serve as a reaction element. In this example, a permanent magnet synchronous motor having a generating function is used as the first motor-generator 11. The ring gear 5 as the output element is integrated with the output gear 12 to output a driving force to the driving wheels 2. Here, although not especially shown in FIG. 3, the vehicle illustrated therein is provided with a conventional differential gear unit, a drive shaft and so on to transmit the torque from the output gear 12 to the driving wheels 2.

The engine 1, the power distribution device 3 and the first motor-generator 11 are arranged on a common axis, and the second motor-generator (MG2) 13 is arranged coaxially therewith but separated. The second motor-generator 13 is also a permanent magnet synchronous motor that is adapted not only to generate a driving force but also to regenerate energy, and connected with the aforementioned output gear 12 through a speed reduction device 14. Specifically, a single-pinion type planetary gear unit is also used as the speed reduction device 14, and as shown in FIG. 3, a sun gear 15 is connected with the second motor-generator 13, a carrier 16 is fixed to a stationary portion 17 such as a housing, and a ring gear 18 is integrated with the output gear 12. Accordingly, the sun gear 4 serves as the first rotary element of the differential mechanism, the carrier 7 serves as the second rotary element of the differential mechanism, and the ring gear 5 serves as the third rotary element of the differential mechanism.

Those motor-generators 11 and 13 are electrically connected with a controller 19 comprising an electric storage device and an inverter. In order to control the controller 19, an electric control unit (as will be called MG-ECU hereinafter) 20 is connected to the controller 19. The MG-ECU 20 is composed mainly of a microcomputer configured to carry out a calculation based on preinstalled data and data or command signal to be inputted thereto, and to output a calculation result to the controller 19 in the form of a command signal. Accordingly, the motor-generators 11 and 13 are operated as the motor or generator depending on the command signal from the controller 19, and torques thereof are also controlled by the controller 19.

The engine 1 is started and stopped electrically. Specifically, provided that the engine 1 is a gasoline engine, an opening degree of a throttle valve, a feeding amount of fuel, a cessation of fuel delivery, an execution, a cessation and a timing of ignition etc. are controlled electrically. For this purpose, another electronic control unit (as will be called E/G-ECU hereinafter) 21 is connected with the engine 1. The E/G-ECU 21 is also composed mainly of a microcomputer configured to carry out a calculation based on preinstalled data and data or command signal to be inputted thereto, and to output a calculation result to the engine 1 in the form of a command signal.

Thus, a prime mover 22 is comprised of the engine 1, the motor-generators 11 and 13, the clutch K0 and the power distribution device 3, and still another electronic control unit (as will be called HV-ECU hereinafter) 23 is provided to control the prime mover 22. The HV-ECU 23 is also composed mainly of a microcomputer configured to carry out after-explained controls by sending command signals to the MG-ECU 20 and the E/G-ECU 21.

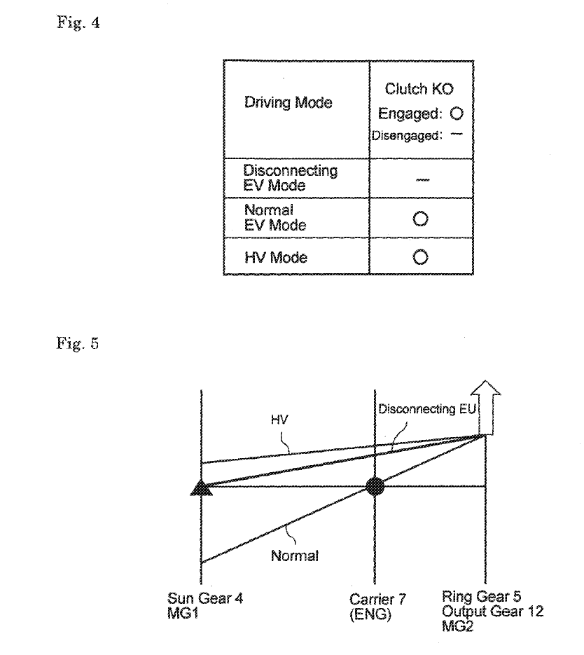

A driving mode of the vehicle shown in FIG. 3 is selected from hybrid mode (abbreviated as the HV mode) in which the vehicle is driven by the power of the engine 1, and electric vehicle mode (abbreviated as the EV mode) in which the vehicle is driven by the electric power. Specifically, the EV mode can be selected from disconnecting EV mode in which the engine 1 is disconnected from the power train 10, and normal EV mode in which the engine 1 is connected with the power train 10. FIG. 4 is a table showing an engagement status of the clutch K0 under each driving mode. As can be seen from FIG. 4, the clutch K0 is disengaged under the disconnecting EV mode. In contrast, the clutch K0 is engaged under the normal EV mode and the HV mode. Specifically, the driving mode of the vehicle is selected from the HV mode, the disconnecting EV mode and the normal EV mode, depending on a running condition of the vehicle such as an opening degree of accelerator, a drive demand, a vehicle speed, a state of charge (abbreviated as SOC hereinafter) of electric storage device and so on. For example, the HV mode is selected when an opening degree of the accelerator is relatively large to keep the vehicle running at relatively high speed. To the contrary, if the SOC is sufficient and the opening degree of the accelerator is relatively small, the normal EV mode is selected to drive the vehicle while keeping the engine 1 in a condition ready to be restarted as necessary. Provided that the vehicle is allowed to be driven under the EV mode, the disconnecting EV mode is selected if it is necessary to reduce a power loss resulting from rotating the engine 1 concurrently.

Here will be explained an operating state of the hybrid drive unit under each driving mode. FIG. 5 is a nomographic diagram of the power distribution device 3. In FIG. 5, each vertical line individually represents the sun gear 4, the carrier 7 and the ring gear 5, and clearances between the sun gear 4 and the carrier 7 and between the carrier 7 and the ring gear 5 are individually determined in accordance with a gear ratio of the planetary gear unit serving as the power distribution device 3. In addition, the vertical direction represents a rotational direction, and a rotational speed is represented at a vertical position. In FIG. 5, the diagonal line as indicated “Disconnecting EV” represents an operating state under the disconnecting EV mode. Under the disconnecting EV mode, the second motor-generator 13 is used as a motor to drive the vehicle. In this situation, the engine 1 is stopped and disconnected from the power train 10 by disengaging the clutch K0, and the first motor-generator 11 is also stopped. Therefore, the sun gear 4 is not rotated, the ring gear 5 is rotated together with the output gear 12 in the forward direction, and the carrier 7 is rotated in the forward direction at a speed reduced in accordance with the gear ratio of the power distribution device 3.

In FIG. 5, the diagonal line as indicated “Normal EV” represents an operating state under the normal EV mode. Under the normal EV mode, the vehicle is driven by the power of the second motor-generator 13, and the engine 1 is stopped. In this situation, therefore, the carrier 7 is stopped, the ring gear 5 is rotated in the forward direction, and the sun gear 4 is rotated in the backward direction. In turn, the diagonal line as indicated “HV” represents an operating state under the HV mode. Under the HV mode, the clutch K0 is engaged and the engine 1 generates the driving force so that the carrier 7 is rotated by the torque in the forward direction. In this situation, a counter torque is applied to the sun gear 4 by operating the first motor-generator 11 as a generator. Consequently, a torque to rotate in the forward direction will appear on the ring gear 5. In this case, the electric power generated by the first motor-generator 11 is delivered to the second motor-generator 13. Therefore, the second motor-generator 13 is driven as a motor and a driving force thereof is transmitted to the output gear 12. Thus, under the HV mode, the power of the engine 1 is partially transmitted to the output gear 12 through the power distribution device 3. The remaining power of the engine 1 is converted into an electric power by the first motor-generator 11 and delivered to the second motor-generator 13. Then, the electric power thus delivered to the second motor-generator 13 is converted into a mechanical power again and delivered to the output gear 12. Such energy regeneration is carried out irrespective of selected driving mode by operating any one of the motor-generators 11 and 13 as a generator, under the situation that the prime mover is not required to output the driving force aggressively.

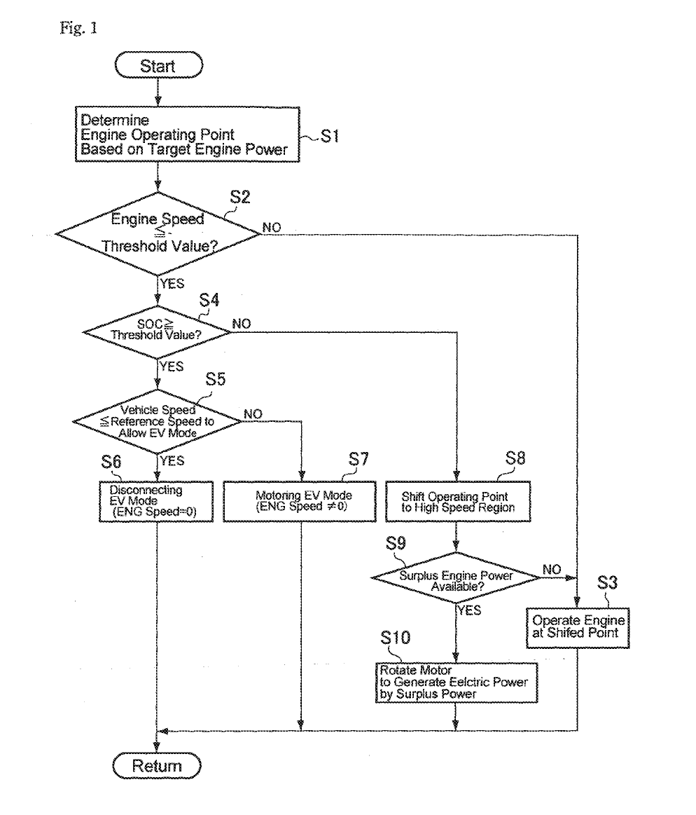

Thus, the hybrid vehicle to which the control system of the present disclosure is applied is allowed to be driven by the electric power while disengaging the clutch K0. By contrast, provided that the SOC of the electric storage device is insufficient or a large diving force is demanded, the engine 1 is started and the power of the engine 1 is transmitted to the power train 10 through the clutch K0. However, if the speed of the engine 1 thus started to shift the driving mode is too low, torque pulses may appear significantly thereby causing shocks. In order to avoid such a disadvantage, the vehicle control system of the present disclosure is configured to control the clutch K0 as shown in FIG. 1. The control example shown in FIG. 1 is carried out repeatedly as long as the main switch of the hybrid vehicle is turned on.

First of all, a target operating point of the engine 1 at which a target engine power based on a required driving force can be generated while achieving a desired fuel economy is determined, and a target speed of the engine 1 to be achieved at the target operating point thus determined is calculated (at step S1). For this purpose, a fuel economy curve is determined in the form of a map using an engine torque and an engine speed as parameters. In the map, specifically, the fuel economy curve is drawn by connecting operating points at which the fuel economy can be optimized. As will be explained in more detail, the target operating point of the engine 1 can be determined on the fuel economy curve thus determined based on the target engine power.

Specifically, as the case of controlling the engine and the motor-generator in the conventional hybrid vehicle, the required driving force can be calculated based on an opening degree of an accelerator and a vehicle speed. Here, the calculation value of the driving force may be adjusted depending on a grade or a class of the vehicle to achieve a required performance or characteristics of the engine. The target engine power is calculated based on the required driving force, and the target operating point at which the target engine power thus calculated can be generated while optimizing the fuel economy is determined in the map at an intersection between a constant output curve of the target engine power and the optimum fuel economy curve. Consequently, the target engine speed and a target torque are determined based on the target operating point thus determined. That is, in order to generate the target engine power, the engine 1 is driven at the target engine speed to generate the target torque. To this end, for example, the speed of the engine 1 is further controlled by the first motor-generator 11, and the torque of the engine 1 is further controlled by adjusting an opening degree of a throttle valve.

Then, it is determined whether or not the target engine speed to be achieved at the target operating point is equal to or lower than a predetermined threshold value (at step S2). According to this example, specifically, a reference speed α to cause resonances in the powertrain 10 for transmitting the torque of the engine 1 to the driving wheels 2 is employed as the threshold value. For example, if the engine speed is lower than the reference speed α, the torque pulses caused by the engine 1 will appear significantly on the powertrain 10 to cause resonances. In this case, therefore, the NVH characteristics of the vehicle may be deteriorated. By contrast, if the engine speed is higher than the reference speed α, noises and vibrations induced by the torque pulses of the engine 1 will be reduced. Therefore, if the engine speed is higher than the reference speed α so that the answer of step S2 is NO, the engine 1 is operated at the target operating point determined at step S1 (at step S3), and then, the routine is returned. Thus, the reference speed α is employed as the threshold value of the engine speed. In addition, a speed region lower than the reference speed α will be called a “low speed region” in the following description.

By contrast, if the engine speed is equal to or lower than the reference speed α so that the answer of step S2 is NO, it is determined whether or not the SOC of the electric storage device is equal to or larger than a predetermined threshold value of the SOC (at step S4). In the hybrid vehicle, when the SOC of the electric storage device becomes smaller than the predetermined value, the electric storage device is charged by rotating the first motor-generator 11 by the engine 1.

If the SOC is larger than the threshold value so that the answer of step S4 is YES, it is determined whether or not the current vehicle speed is equal to or lower than a reference speed possible to drive the vehicle under the disconnecting EV mode (at step S5). Under the disconnecting EV mode, the clutch K0 is disengaged so that the engine 1 is disconnected from the power train 10, and the first motor-generator 11 is stopped. In this situation, the sun gear 4 of the power distribution device 3 is not rotated but the ring gear 5 is rotated together with the output gear 12. Meanwhile, the carrier 7 is rotated at the speed reduced with respect to the rotational speed of the ring gear 5 in accordance with the gear ratio of the planetary gear mechanism, and the rotational speed of the carrier 7 is increased with an increase in the vehicle speed. When the vehicle speed is increased and the driving mode is shifted from the disconnecting EV mode to the HV mode, the first motor-generator 11 is rotated in the direction to lower the rotational speed of the carrier 7 to zero as shown in FIG. 5, and then the clutch K0 is engaged. If the rotational speed of the first motor-generator 11 is thus changed under the condition that the vehicle is driven at a high speed, a rotational speed of the pinion gear 6 may be increased excessively thereby damaging the pinion gear 6. Therefore, the reference speed to allow the vehicle to be driven under the disconnecting EV mode is set to the speed low enough to prevent the rotational speed of the pinion gear 6 from being changed drastically by the first motor-generator 11, even if the driving mode is shifted from the disconnecting EV mode to the HV mode by engaging the clutch K0. To this end, such reference speed is determined based on the gear ratio of the planetary gear mechanism and the vehicle speed.

If the current vehicle speed is equal to or lower than the reference speed so that the answer of step S5 is YES, the driving mode is shifted to the disconnecting EV mode (at step S6). As described, under the disconnecting EV mode, the clutch K0 is disengaged to disconnect the engine 1 from the power train 10. In this situation, therefore, the engine 1 is allowed to be stopped. The routine is then returned. When the large driving force is required and the driving mode is therefore shifted from the disconnecting EV mode to the HV mode, a so-called “concurrent start” of the engine 1 is carried out. In this situation, specifically, the engine 1 is started while causing the clutch K0 to slip. In other words, the engine 1 is started while gradually increasing an engagement pressure of the clutch K0. Therefore, the output torque of the engine 1 can be transmitted promptly to the driving wheels 2.

By contrast, if the current vehicle speed is higher than the reference speed so that the answer of step S5 is NO, the clutch K0 is engaged to rotate the engine 1 by the first motor-generator 11, that is, the driving mode is shifted to a motoring EV mode (at step S7). In this case, specifically, the first motor-generator 11 is rotated in the direction to lower the rotational speed of the carrier 7 to zero as shown in FIG. 5, and then the clutch K0 is engaged to carry out a motoring of the engine 1 by the first motor-generator 11. Thus, at step S7, the clutch K0 is engaged a low vehicle speed. Therefore, the pinion gear 6 will not be rotated excessively even when the first motor-generator 11 is rotated in the direction to lower the rotational speed of the carrier 7 to zero. For this reason, the pinion gear 6 can be prevented from being damaged. The routine is then returned.

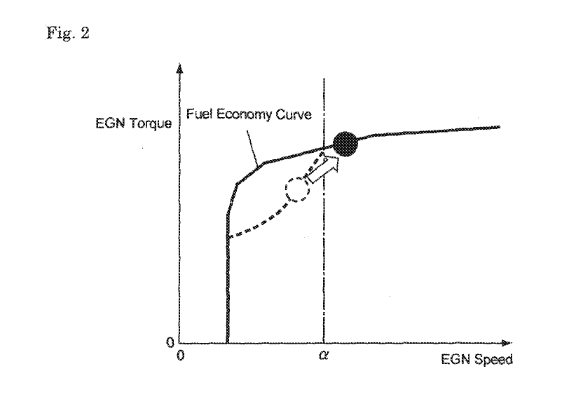

If the SOC is smaller than the threshold value so that the answer of step S4 is NO, the vehicle is driven under the HV mode and the operating point of the engine 1 is shifted to a region higher than the reference speed α (at step S8). In this case, it is necessary to charge the electric storage device by rotating the first motor-generator 11 by the engine 1. For this purpose, a higher power of the engine 1 is required. Therefore, in order to shift the operating point to the region higher than the reference speed α, the required engine power is calculated based on the required driving force taking into consideration the current SOC. Then, the operating point is shifted to a point on the optimum fuel economy curve in the region higher than the reference speed α at which the required engine power thus calculated can be generated while optimizing the fuel economy. The operating point thus shifted is illustrated in FIG. 2. In FIG. 2, the broken line represents the operating point of the engine 1 in the low speed region. As described, if the rotational speed of the engine 1 is lower than the reference speed α, the torque pulses will appear on the power train 10 significantly. Therefore, if the speed of the engine 1 is lower than the reference speed α, the operating point of the engine 1 is controlled in a manner such that the torque pulses are reduced while deviating from the optimum fuel economy curve.

Then, it is determined whether or not a surplus engine power is available (at step S9). If the power generated by engine 1 driven at the operating point determined at step S8 is larger than the power necessary to drive the vehicle so that the answer of step S9 is YES, the engine 1 is kept driven at the operating point determined at step S8 and the first motor-generator 11 is rotated by the surplus power of the engine 1 to generate the electric power (at step S10). The electric power thus generated by the first motor-generator 11 is stored into the electric storage device, and then the routine is returned.

In contrast, if the surplus power of the engine 1 is not available so that the answer of step S9 is NO, the routine advances to step S3 to drive the engine 1 at the operating point determined at step S8 without generating the electric power by the first motor-generator 11, and then the routine is returned.

Thus, according to the present disclosure, the vehicle is driven under the disconnecting EV mode without driving the engine 1 provided that the engine speed is lower than the reference speed α, that the SOC of the electric storage device is sufficient, and that the vehicle speed is low. Therefore, the torque pulses of the engine 1 and resultant vibrations are reduced in the low speed region. In addition, when starting the engine 1, the torque pulses of the engine 1 and an engagement shock can be suppressed by engaging the clutch K0 while causing a slip. Therefore, a spring having high stiffness may be used in a torsional damper for damping the vibrations of the power train. Consequently, an acceleration response of the vehicle can be improved.

In contrast, if the engine speed is lower than the reference speed α but the current vehicle speed is higher than the predetermined speed, the clutch K0 is engaged to shift the driving mode to the motoring EV mode. In this case, specifically, the clutch K0 is engaged and the engine speed is raised by the first motor-generator 11. Therefore, the pinion gear 6 will not be rotated excessively even when the clutch K0 is engaged. In addition, when the driving mode is shifted to the HV mode, the rotational speed can be raised smoothly to start the engine 1. In this case, the current to be applied to the first motor-generator 11 can be reduced.

In addition, if the engine speed is lower than the reference speed α but the SOC of the electric storage device is smaller than the threshold value, the driving mode is shifted to the HV mode. In this case, the operating point of the engine 1 is shifted to the region higher than the reference speed α, and if the engine 1 is allowed to generate the power higher than the required power to drive the vehicle at the operating point thus shifted, the first motor-generator 11 is rotated by the surplus power of the engine 1 to generate the electric power. In this case, the electric storage device is thus allowed to be charged efficiently utilizing the surplus power of the engine 1.

1. A control system for a vehicle in which a prime mover includes an engine and a motor, comprising:
a controller that is configured to
determine a target operating point of the engine at which a target engine power based on a required driving force can be generated while achieving a desired fuel economy; and
shift a driving mode to the electric vehicle mode to drive the vehicle by the motor, if a target engine speed to be achieved at the target operating point is lower than a predetermined threshold value.

2. The control system for a vehicle as claimed in claim 1, wherein the threshold value includes a reference speed to cause resonances in a power train for transmitting a torque of the engine to driving wheels.

3. The control system for a vehicle as claimed in claim 1, wherein the power train is comprised of a clutch adapted to be engaged to selectively connect the engine with the power train, in a manner such that a torque transmitting capacity thereof is changed gradually.

4. The control system for a vehicle as claimed in claim 3,
wherein the controller is further configured to disengage the clutch if the target engine speed is lower than the threshold value.

5. The control system for a vehicle as claimed in claim 1,
wherein the vehicle is comprised of a power distribution device having three rotary elements to perform a differential action;
wherein the motor includes a first motor having a generating function and a second motor; and
wherein the first motor is connected with a first rotary element, the engine is connected with a second rotary element through the clutch, and the second motor is connected with a third rotary element serving as an output element to transmit a driving force to the driving wheels.

6. The control system for a vehicle as claimed in claim 5, wherein the driving mode is shifted to a motoring electric vehicle mode to engage the clutch to raise the speed of the engine by the first motor, if the vehicle is driven by the second motor while disengaging the clutch and a speed of the vehicle exceeds a predetermined reference speed.

7. The control system for a vehicle as claimed in claim 5, wherein the vehicle is comprised of an electric storage device connected with the first motor and the second motor; and
the controller is further configured to:
shift the target operating point of the engine to another target operating point at which the target engine speed is higher than the threshold value, if the target engine speed achieved at the target operating point of the engine is lower than the threshold value, and a state of charge of the electric storage device is smaller than a predetermined threshold value;
engage the clutch to drive the engine at said another operating point; and
charge the electric storage device by generating an electric power by rotating the first motor by a surplus power of the engine, if the clutch is engaged, and the power generated by engine driven at said another operating point is larger than the power necessary to drive the vehicle.
